(19) United States
(12) Patent Application Publication
(10) Pub. No.: US 2020/0271349 A1
(43) Pub. Date: Aug. 27, 2020

(54) HEAT EXCHANGE TYPE VENTILATION DEVICE

(71) Applicant: PANASONIC INTELLECTUAL PROPERTY MANAGEMENT CO., LTD., Osaka (JP)

(72) Inventors: Masahide FUKUMOTO, Aichi (JP); Yousuke HAMADA, Aichi (JP)

(21) Appl. No.: 16/844,739

(22) Filed: Apr. 9, 2020

Related U.S. Application Data
(63) Continuation of application No. PCT/JP2018/040027, filed on Oct. 29, 2018.

(30) Foreign Application Priority Data
Oct. 30, 2017 (JP) 2017-209250

(51) Int. Cl. F24F 12/00; F24F 7/08

(52) U.S. Cl. CPC F24F 12/006; E06B 7/02; F24F 7/08

(57) ABSTRACT

A heat exchange ventilator includes a window frame, a lighting section inside the window frame; and a heat exchange element superimposed on the lighting section. The window frame includes an exhaust flow inlet, an exhaust flow outlet, an air supply flow inlet, an air supply flow outlet, an exhaust blower, and an air supply blower. The heat exchange element includes multiple heat transfer plates defining multiple air passages. Each heat transfer plate separates two air passages among the multiple air passages. Heat exchange plates are optically transparent and exchange sensible heat or total heat. The air passages include air supply passages and exhaust passages. Each air supply passage is between the air supply flow inlet and the air supply flow outlet. Each exhaust passage is between the exhaust flow inlet and the exhaust flow outlet. The air supply passages and the exhaust passages are alternatively arranged one by one.

### TECHNICAL FIELD

The present disclosure relates to a heat exchange ventilator.

### BACKGROUND ART

In recent years, great importance has been put on energy savings in the field of housing as global warming progresses. As to energy consumption in houses, energy consumed for hot-water supplying, lighting, air conditioning, and ventilation is comparatively larger, and therefore, technologies for reducing such energy consumption has been greatly desired.

In the above-mentioned energy consumption, when attention is given to air conditioning load in houses, the air conditioning load includes heat lost from the framework of a house (cold in the case of air cooling) and heat lost by ventilation. In the last decades, the heat lost from the framework of a house has been reduced because of considerable improvements in heat insulation and airtightness of houses. On the other hand, in order to reduce the heat lost by ventilation, a heat exchange ventilator configured to perform heat exchange between an exhaust flow and an air supply flow is effective.

In particular, the heat exchange ventilator has a great heat-recovery effect in cold climate areas having a great difference between the indoor temperature and the outdoor temperature or in winter, and accordingly can reduce air conditioning energy. However, a conventional heat exchange ventilator is installed in, for example, a ceiling space under a roof, and ducts need to be routed in order to distribute air to rooms, and therefore, the conventional heat exchange ventilator needs a large-scale installation work.

To simplify the installation work of a heat exchange ventilator, a study has been conducted in which a heat exchange ventilator is mounted into a window, and ventilation is performed while heat is recovered without using a duct (for example, see Patent Literature 1).

In order to realize the above-mentioned study, the above-mentioned type of heat exchange ventilator had the following configuration.

As illustrated in FIG. 10, heat exchange ventilator 101 is embedded in window frame 102. As illustrated in FIG. 11, heat exchange ventilator 101 includes heat exchange element 105 and exhaust blower 106 in an exhaust passage configured to establish communication between exhaust flow inlet 102 and exhaust flow outlet 104. Heat exchange ventilator 101 further includes heat exchange element 105 and air supply blower 109 in an air supply passage configured to establish communication between air supply flow inlet 107 and air supply flow outlet 108. By operating exhaust blower 106 and air supply blower 109, heat exchange between an exhaust flow and an air supply flow is carried out inside heat exchange element 105.

### CITATION LIST

Patent Literature 1: Japanese Unexamined Patent Application Publication (Translation of PCT Application) No. 2013-525733

### SUMMARY OF INVENTION

As described above, in recent years, the desire to reduce air conditioning load in houses has grown, and a heat exchange ventilator having excellent energy-saving efficiency has been desired. On the other hand, a window frame for buildings has an important role for the design and beauty of buildings, and accordingly needs to be in harmony with peripheral members of the window frame, such as a wall material. Therefore, the miniaturization of window frames is highly desired.

However, the above-mentioned conventional heat exchange ventilator has a problem that a heat transfer member configured to establish heat exchange between an air supply flow and an exhaust flow, an air supply blower, and an exhaust blower are provided inside a window frame, and therefore the window frame is large in size, and thereby spoils external appearance. Furthermore, since the heat transfer member is mounted in the window frame, an area necessary for the heat exchange is limited to an area of the window frame. Therefore, there is a problem that the area is too small for the heat exchange and sufficient heat exchange cannot be carried out, and, as a result, particularly in winter, the temperature of air blowing into a room is decreased to cause a loss in comfortability.

Therefore, an object of the present disclosure is to provide a heat exchange ventilator making the miniaturization of a window frame possible and capable of preventing a decrease in the temperature of air blowing into a room and enhancing comfortability.

To accomplish this object, a heat exchange ventilator according to one aspect of the present disclosure includes a window frame, a lighting section provided inside the window frame, and a heat exchange element disposed in the lighting section. The window frame includes an exhaust flow inlet provided on an indoor side and configured to take in indoor air, an exhaust flow outlet provided on an outdoor side and configured to blow out the indoor air, an air supply flow inlet provided on the outdoor side and configured to take in outdoor air, an air supply flow outlet provided on the indoor side and configured to blow out the outdoor air, an exhaust blower configured to send the indoor air from the exhaust flow inlet to the exhaust flow outlet, and an air supply blower configured to send the outdoor air from the air supply flow inlet to the air supply flow outlet. The heat exchange element includes a plurality of heat transfer plates defining a plurality of air passages. Each heat transfer plate separates two air passages among the plurality of air passages. The plurality of heat exchange plates are optically transparent and configured to exchange sensible heat or total heat. The plurality of air passages includes one or more air supply passages and one or more exhaust passages. The one or more air supply passages each are provided between the air supply flow inlet and the air supply flow outlet. The one or more exhaust passages each are provided between the exhaust flow inlet and the exhaust flow outlet. The one or more air supply passages and the one or more exhaust passages are alternatively arranged one by one.

According to one aspect of the present disclosure, the heat exchange element is disposed in the lighting section provided inside the window frame, and the air supply blower and the exhaust blower are disposed in the window frame. Thus, the size of the window frame can be reduced. Furthermore, since the heat exchange element is disposed in the lighting section, the heat exchange element can be larger in size than a conventional heat exchange element disposed in a window frame, and accordingly has the effect of enhancing heat exchange efficiency.

Thus, the present disclosure provides the heat exchange ventilator the use of which makes possible the miniaturization of a window frame and allows more efficient heat exchange between indoor air and outdoor air, and thereby leads to higher comfortability.

### BRIEF DESCRIPTION OF DRAWINGS

FIG. 1 is a schematic elevation view illustrating an installation example of a heat exchange ventilator according to a first embodiment of the present disclosure.

FIG. 2 is a schematic perspective view of the heat exchange ventilator when the heat exchange ventilator is viewed from inside a room.

FIG. 3 is a schematic cross-sectional view of the heat exchange ventilator.

FIG. 4 is a schematic cross-sectional view of the heat exchange ventilator including a low thermal radiation layer.

FIG. 5 is a schematic cross-sectional view of the heat exchange ventilator including a thermal insulating layer.

FIG. 6 (a) and FIG. 6 (b) are schematic perspective views of the heat exchange ventilator including a cross-flow heat exchange element when the heat exchange ventilator is viewed from inside and outside the room, respectively.

FIG. 7 is a cross-sectional perspective view of the heat exchange ventilator including the cross-flow heat exchange element when the heat exchange ventilator is viewed from inside the room.

FIG. 8 is a schematic cross-sectional view of the heat exchange ventilator into which a filter is installed.

FIG. 9 is a schematic cross-sectional view of the heat exchange ventilator.

FIG. 10 is a schematic perspective view illustrating an installation example of a conventional heat exchange ventilator.

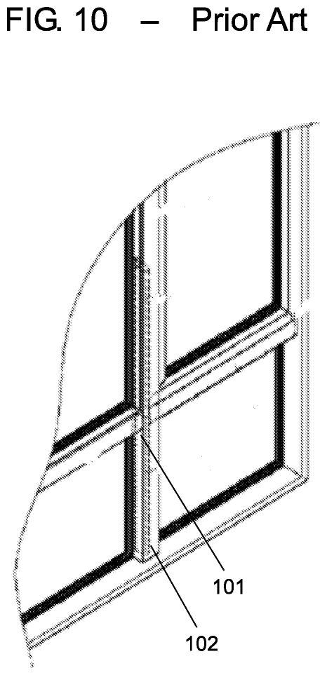

FIG. 11 is a schematic perspective view illustrating a configuration of the conventional heat exchange ventilator.

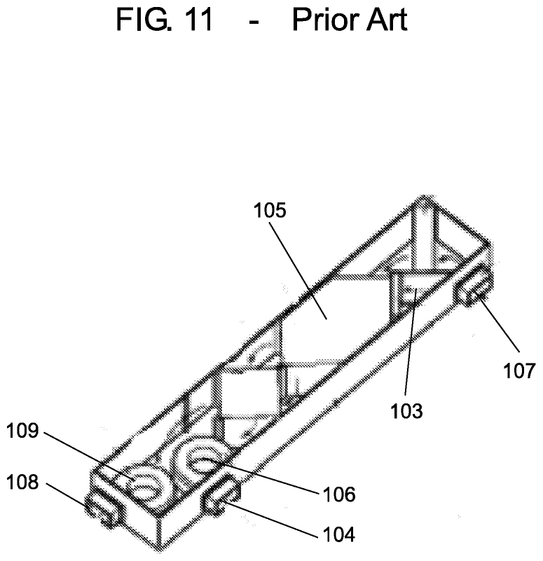

### DESCRIPTION OF EMBODIMENTS

Hereinafter, embodiments of the present disclosure will be described based on the drawings. Note that the following embodiments are merely examples of a heat exchange ventilator to specify technical ideas of the present disclosure, and the present disclosure does not limit the heat exchange ventilator to the followings. Furthermore, members described in claims are not limited to members in examples. In particular, the size, material, shape, and the relative positions of constituents that are described in the embodiments do not limit the range of the present disclosure, but are merely explanation examples, unless otherwise specified. Note that, for example, the size of members and a positional relation between the members are sometimes exaggeratingly illustrated in the drawings in order to make an explanation clear. Furthermore, in the following description, the same or similar members are assigned the same names and reference numerals, and therefore detailed explanations thereof will be suitably omitted. Furthermore, as to constituents of the present disclosure, the same member may constitute a plurality of constituents, that is, one member constitutes a plurality of constituents, or, on the other hand, the function of one member may be realized by a plurality of members. Furthermore, descriptions provided in some of the examples and embodiments can be applied to other examples and embodiments.

A heat exchange ventilator according to one aspect of the present disclosure includes a window frame, a lighting section provided inside the window frame, and a heat exchange element superimposed on the lighting section. The window frame includes an exhaust flow inlet provided on an indoor side and configured to take in indoor air, an exhaust flow outlet provided on an outdoor side and configured to blow out the indoor air, an air supply flow inlet provided on the outdoor side and configured to take in outdoor air, an air supply flow outlet provided on the indoor side and configured to blow out the outdoor air, an exhaust blower configured to send the indoor air from the exhaust flow inlet to the exhaust flow outlet, and an air supply blower configured to send the outdoor air from the air supply flow inlet to the air supply flow outlet. The heat exchange element includes a plurality of heat transfer plates defining a plurality of air passages. Each heat transfer plate separates two air passages among the plurality of air passages. The plurality of heat exchange plates are optically transparent and configured to exchange sensible heat or total heat. The plurality of air passages includes one or more air supply passages and one or more exhaust passages. The one or more air supply passages each are provided between the air supply flow inlet and the air supply flow outlet. The one or more exhaust passages each are provided between the exhaust flow inlet and the exhaust flow outlet. The one or more air supply passages and the one or more exhaust passages are alternatively arranged one by one.

The heat exchange element is thus disposed in the lighting section, whereby a heat exchange element conventionally embedded in a window frame is made unnecessary, so that the miniaturization of the window frame can be achieved. Furthermore, since the heat exchange element is disposed in the lighting section, the heat exchange element can be larger in size than a conventional heat exchange element, so that the effect of enhancing heat exchange efficiency is achieved. Furthermore, the heat exchange element is disposed in the lighting section, and therefore, in winter, the heat exchange element can not only exchange the heat of air taken into the inside of a room and the heat of air discharged to the outside of the room, but also acquire solar radiation. Thus, the surface temperature of the heat transfer plate inside the heat exchange element rises, whereby the temperature of air flowing through the air supply passage can be increased. Furthermore, the heat transfer plate is optically transparent, and thereby can carry out a lighting function as a window. Thus, as described above, without losing a function as a window, the window frame can be reduced in size, and the heat exchange element can be larger in size, and heat exchange efficiency can be enhanced. Thus, there can be provided the heat exchange ventilator capable of achieving efficient heat exchange between indoor air and outdoor air and offering higher comfortability.

The heat exchange element may be configured to be disposed on the indoor side of the lighting section, and have, on a side facing the lighting section, a low thermal radiation layer configured to interrupt heat radiation. This configuration can prevent heat transfer caused by heat radiation. Thus, in winter, indoor temperature is higher than outdoor temperature, and therefore, heat transferred from the inside of a room to the outside thereof can be reflected toward a heat exchange element side, whereby the temperature of air in the air supply passage can be further increased. In summer, outdoor temperature is higher than indoor temperature, and therefore, heat transferred from the outside of a room to the inside thereof can be reflected toward the outside of the room. Therefore, in both winter and summer, air having a comfortable temperature can be taken into the inside of a room, and thus, higher comfortability can be achieved.

The one or more exhaust passages may include an indoor-side air passage which is the closest to a room among the plurality of air passages. The one or more air supply passages may include an outdoor-side air passage which is the farthest to the room among the plurality of air passages. This configuration can substantially prevent indoor air from being cooled by the air supply flow passing through the air supply passages. Furthermore, the air supply flow passing through the air supply passages is warmed by light via the lighting section, so that the temperature of the air supply flow can be increased.

The heat exchange element may be configured to be in contact with the lighting section via a hollow thermal-insulating layer. With this configuration, the hollow thermal-insulating layer can be provided between the outside of a room and the heat exchange element, whereby the influence of heat on the air supply passage from the outside of the room can be reduced, so that the temperature of air supply and the temperature of exhaust can be efficiently exchanged.

An air flow direction of the one or more air supply passages may oppose an air flow direction of the one ore more exhaust passages. With this configuration, supplied air opposes exhaust, whereby heat exchange can be carried out in a uniform temperature distribution, so that temperature exchange efficiency in the heat transfer plate can be enhanced.

It may be configured such that the exhaust flow inlet is provided in one side part of one pair of side parts of the window frame, and the exhaust flow outlet is provided in another side part of the one pair of the side parts of the window frame; the air supply flow inlet is provided in one side part of another pair of side parts of the window frame, and the air supply flow outlet is provided in another side part of the another pair of the side parts of the window frame; and the air flow direction of the one or more exhaust passages are orthogonal to the air flow direction of the one or more air supply passages.

Thus, the air supply flow inlet, the air supply passage, and the air supply flow outlet are configured to be linearly arranged, whereby a simple air passage structure with fewer turns is achieved. Accordingly, pressure losses are reduced, whereby power required for air-blowing can be reduced. In addition, the exhaust flow inlet, the exhaust flow outlet, the air supply flow inlet, and the air supply flow outlet are disposed in the four side parts of the window frame, respectively, whereby fresh outdoor air supplied from the air supply flow outlet to the inside of a room can be prevented from being discharged from the exhaust flow inlet to the outside of the room. Furthermore, indoor air discharged from the exhaust flow outlet to the outside of the room can be prevented from being supplied from the air supply flow inlet to the inside of the room. Thus, discharged indoor air can be prevented from getting mixed with supplied outdoor air, so that efficient ventilation can be achieved.

Hereinafter, embodiments of the present disclosure will be described with reference to the drawings.

### First Embodiment

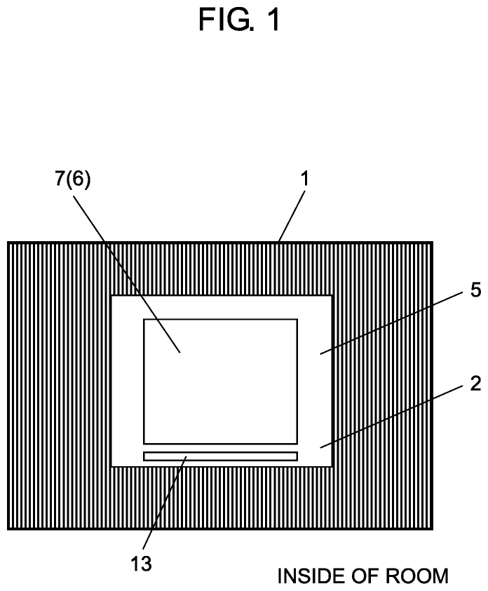

In FIG. 1, heat exchange ventilator 2 is mounted in wall 1 of a house. Heat exchange ventilator 2 includes window frame 5 having a rectangular external shape, lighting section 6 provided inside window frame 5, and heat exchange element 7 being optically transparent and superimposed on lighting section 6. Note that later-described air supply flow outlet 13 is provided on the indoor side of the lower side part of window frame 5.

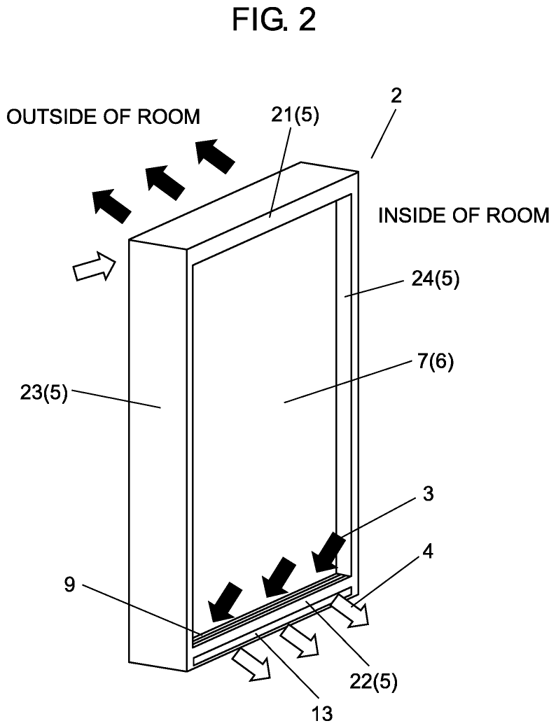

As illustrated in FIG. 2, window frame 5 has a rectangular external shape, and, when viewed from the indoor side, window frame 5 includes: upper side part 21 on the upper side of window frame 5; lower side part 22 positioned on the lower side of window frame 5 and paired with upper side part 21; left side part 23 on the left side of window frame 5; and right side part 24 positioned on the right side of window frame 5 and paired with left side part 23. In window frame 5, the right and left ends of upper side part 21 are coupled with the upper end of right side part 24 and the upper end of left side part 23, respectively; and the right and left ends of lower side part 22 are coupled with the lower end of right side part 24 and the lower end of left side part 23, respectively.

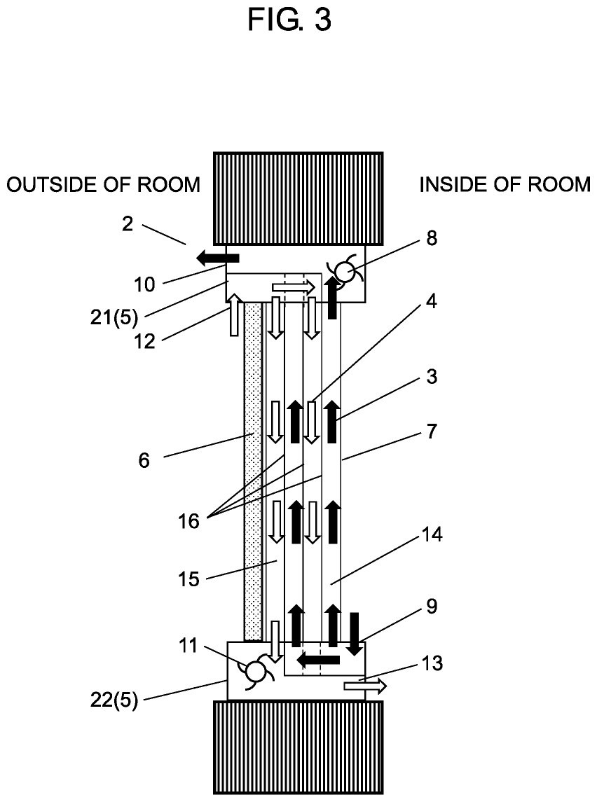

As illustrated in FIG. 2 and FIG. 3, lighting section 6 and heat exchange element 7 are fixed to window frame 5 including upper side part 21, lower side part 22, left side part 23, and right side part 24. Lighting section 6 is formed of an optically transparent material that is typically a glass material or a material such as reinforced plastic, for example. Heat exchange element 7 is also formed of an optically transparent material, and details thereof will be described later.

As illustrated in FIG. 2 and FIG. 3, indoor air (hereinafter, referred to as indoor air 3) is taken in from exhaust flow inlet 9 provided on the indoor side of lower side part 22, as indicated by black arrows, and is discharged from exhaust flow outlet 10 provided on the outdoor side of upper side part 21 via heat exchange ventilator 2 to the outside of a room, as indicated by black arrows. Outdoor air (hereinafter, referred to as outdoor air 4) is taken in from air supply flow inlet 12 provided on the outdoor side of upper side part 21, as indicated by white arrows, and is taken into the inside of the room from air supply flow outlet 13 provided on the indoor side of lower side part 22 via heat exchange ventilator 2, as indicated by white arrows.

Then, with this configuration, ventilation is performed, and also, at the time of the ventilation, emitted heat of indoor air 3 is transmitted to outdoor air 4 taken into the inside of the room. Thus, unnecessary heat-discharge is substantially prevented, and heat is recovered into the inside of the room.

As illustrated in FIG. 3, in the present embodiment, heat exchange ventilator 2 includes window frame 5 formed of a hollow member, lighting section 6 provided inside window frame 5, and heat exchange element 7 superimposed on lighting section 6. When exhaust blower 8 provided in upper side part 21 of window frame 5 is driven, indoor air 3 is taken in from exhaust flow inlet 9 provided on the indoor side of lower side part 22. Taken-in indoor air 3 is discharged to the outside of the room from exhaust flow outlet 10 provided on the outdoor side of upper side part 21, via exhaust passage 14 of heat exchange element 7 and exhaust blower 8.

By driving air supply blower 11 provided in lower side part 22 of window frame 5, outdoor air 4 is taken in from air supply flow inlet 12 provided on the outdoor side of upper side part 21. Taken-in outdoor air 4 is introduced into the inside of the room from air supply flow outlet 13 provided on the indoor side of lower side part 22, via air supply passage 15 of heat exchange element 7 and air supply blower 11. Here, exhaust flow outlet 10 and air supply flow inlet 12 are respectively disposed in different faces of upper side part 21 in a rectangular shape so that air blown out from exhaust flow outlet 10 in upper side part 21 to the outside of the room is not introduced into the inside of the room from air supply flow inlet 12. Similarly, air supply flow outlet 13 and exhaust flow inlet 9 are respectively disposed in different faces of lower side part 22 in a rectangular shape so that air blown out from air supply flow outlet 13 in lower side part 22 to the inside of the room is not introduced into the outside of the room from exhaust flow inlet 9. Note that examples of a blower used as exhaust blower 8 or air supply blower 11 include a cross flow fan. Heat exchange element 7 includes exhaust passage 14 provided between exhaust flow inlet 9 and exhaust flow outlet 10, and air supply passage 15 provided between air supply flow inlet 12 and air supply flow outlet 13. Exhaust passage 14 and air supply passage 15 are separated by heat transfer plate 16 being optically transparent. Exhaust passages 14 and air supply passages 15 are alternately laminated one by one via heat transfer plates 16.

According to heat exchange ventilator 2 of the present embodiment, by operating heat exchange ventilator 2, heat is transferred in heat exchange element 7 from indoor air 3 discharged to supplied outdoor air 4 via heat transfer plate 16, whereby the heat can be recovered into the room. By superimposing heat exchange element 7 on lighting section 6, heat exchange element 7 conventionally provided in window frame 5 can be made unnecessary, so that window frame 5 can be reduced in size. Furthermore, the area of lighting section 6 can be made larger than the area of window frame 5, so that the efficiency of heat exchange from discharged indoor air 3 to supplied outdoor air 4 can be enhanced. Furthermore, in winter, heat exchange element 7 acquires solar radiation because heat exchange element 7 is superimposed on lighting section 6. Thus, the surface temperature of heat transfer plate 16 provided inside heat exchange element 7 rises, whereby the temperature of air flowing through air supply passage 15 can be increased. In addition, heat transfer plate 16 is optically transparent, and thus carries out a lighting function as a window.

Thus, heat exchange ventilator 2 having window frame 5 excellent in design without losing a function as a window can be provided. In addition, since heat exchange element 7 can achieve higher heat-exchange efficiency, heat exchange ventilator 2 capable of reducing air conditioning load all the year around can be provided. Furthermore, there can be provided heat exchange ventilator 2 capable of, particularly in winter, increasing the blowing temperature of the air supply flow by making use of solar radiation, and supplying air having a comfortable temperature.

Note that, for heat exchange, heat transfer plate 16 being optically transparent may be formed of a material that transfers only heat, for example, resin such as polypropylene or polycarbonate, or a glass material conventionally used for windows and capable of sensible heat exchange. Alternatively, heat transfer plate 16 may be formed of a material capable of total heat exchange to transfer both heat and humidity, for example, resin such as polyurethane.

For window frame 5 formed of a hollow member, metal or resin is typically used. Examples of the metal include aluminum which is lightweight. Examples of the resin include vinyl chloride and polycarbonate which have high rigidity. To prevent heat ingress from the outside of a room, resin having lower thermal conductivity than metal is preferably used.

As illustrated in FIG. 3, heat exchange ventilator 2 of the present embodiment has a configuration in which exhaust passages 14 and air supply passages 15 are alternately arranged (superimposed) one by one via heat transfer plate 16. Of the air passages, an air passage on the indoor side is preferably one of exhaust passages 14. This configuration can substantially prevent indoor air from being cooled by the air supply flow (outdoor air 4) passing through air supply passage 15. On the other hand, of the air passages, an air passage on the outdoor side is preferably one of air supply passages 15. With this configuration, heat is added, by incident light via lighting section 6, to the air supply flow passing through air supply passage 15 so that the temperature of the air supply flow can be increased.

As illustrated in FIG. 3, in heat exchange ventilator 2 of the present embodiment, air supply flow inlet 12 is provided in the lower face of upper side part 21. This configuration can prevent solids such as dust in an outdoor space from entering into heat exchange element 7.

Hereinbefore, the present disclosure has been described based on the embodiments. Persons skilled in the art understand that these embodiments are merely examples, and various modifications can be made to combinations of the constituents and the processes, and such modifications are included within the scope of the present disclosure.

As illustrated in FIG. 3, heat exchange ventilator 2 of the present embodiment has a two-layer structure in which lighting section 6 is provided on the outdoor side and heat exchange element 7 is provided on the indoor side, but, the structure of heat exchange ventilator 2 is not limited to the above-mentioned structure. For example, lighting section 6 may be provided also on the indoor side so that heat exchange ventilator 2 has a three-layer structure, namely, lighting section 6 on the outdoor side/heat exchange element 7/lighting section 6 on the indoor side. Thus, heat exchange ventilator 2 having window frame 5 excellent in design without losing a function as a window even on the indoor side can be provided.

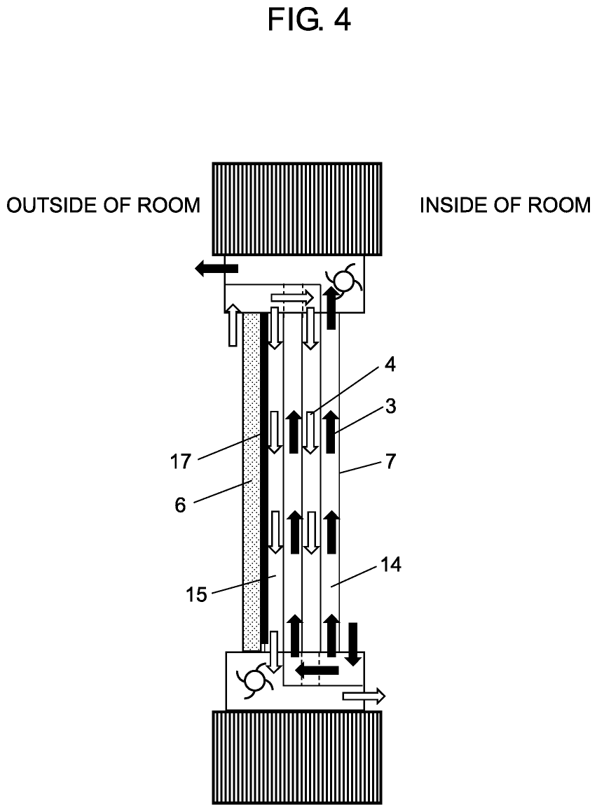

As illustrated in FIG. 4, heat exchange element 7 may be configured to include, on the outdoor side (a side facing lighting section 6) of heat exchange element 7, low thermal radiation layer 17 coated with a low emissivity metal.

With this configuration, heat that is conventionally transferred from the inside of a room to the outside thereof because indoor temperature is higher than outdoor temperature in winter can be reflected toward the heat exchange element 7. Therefore, radiant heat can be applied to the air supply flow (outdoor air 4) in air supply passage 15, so that the air supply flow with a further increased air temperature can be blown into the room. Heat that is conventionally transferred by radiation from the outside of a room to the inside thereof outdoor because temperature is higher than indoor temperature in summer can be reflected toward the outdoor side. Accordingly, it is less likely that radiant heat is added to the air supply flow in air supply passage 15. Thus, air can be blown into the room without increasing the air temperature of the air supply flow.

Accordingly, in winter, the blowing temperature of the air supply flow can be increased, whereas, in summer, the blowing temperature of the air supply flow can be substantially prevented from rising. Thus, all the year around, the air supply flow having a comfortable temperature can be taken into the inside of a room, so that the effect of enhancing comfortability can be achieved.

Note that, as the low emissivity metal used herein, a metal mainly containing silver is known.

The film thickness of low thermal radiation layer 17 is preferably in a range of 50 nm to 500 nm. Low thermal radiation layer 17 having a film thickness of 50 nm or less causes a decrease in reflection of heat radiation. Low thermal radiation layer 17 having a film thickness of 500 nm or more causes a decrease in optical transparency. Thus, when the film thickness is in a range of 50 nm to 500 nm, a function as a window is not lost, the reflection of heat radiation can be secured, high heat-exchange efficiency is achieved, and air having a comfortable temperature can be taken in.

Low thermal radiation layer 17 is formed by, for example, sputtering, electron beam evaporation, or ion plating.

Heat transfer plate 16 may be configured to have a thickness of 10 μm or more and 500 μm or less. When heat transfer plate 16 is a thin film having a thickness of 500 μm or less, thermal conductivity can be improved and high temperature-exchange-efficiency can be achieved. When heat transfer plate 16 has a thickness of less than 10 μm, heat transfer plate 16 bends in a pressure produced during ventilation, and blockages an air passage to cause ventilation resistance. Hence, heat transfer plate 16 having a thickness of 10 μm or more has a necessary rigidity, so that air passage blockage caused by the bending can be substantially prevented.

Thus, while air passage blockage is substantially prevented, high heat-exchange efficiency is achieved, and air having a comfortable temperature can be taken in, so that higher comfortability can be achieved.

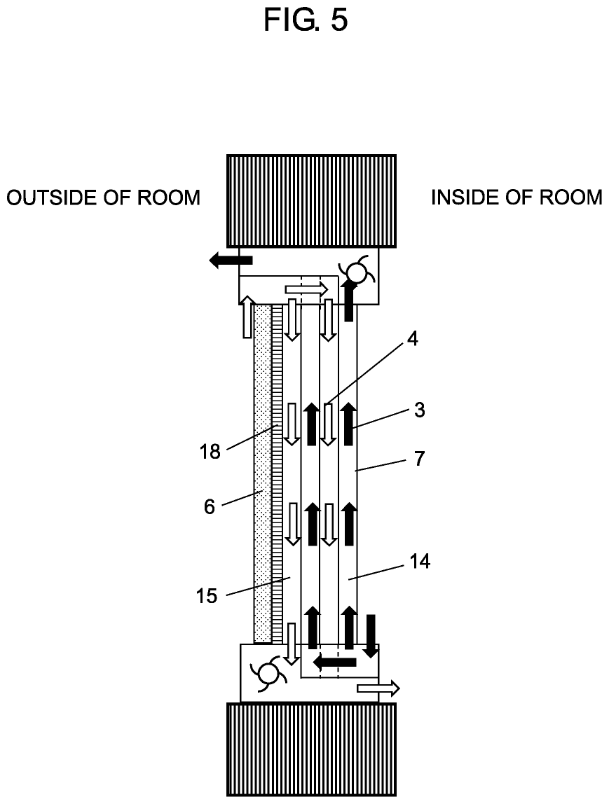

As illustrated in FIG. 5, heat exchange element 7 may be configured to include, on the outdoor side (a side facing lighting section 6), hollow thermal insulating layer 18 partitioned with an optically transparent plate.

The optically transparent plate used herein to constitute thermal insulating layer 18 may be formed of, for example, resin, such as polypropylene or polycarbonate, or a glass material conventionally used for windows.

Thus, a hollow layer has a low thermal conductivity of air and thereby functions as thermal insulating layer 18, so that heat transfer from the outside of a room to heat exchange element 7 can be substantially prevented. For example, in winter, heat transfer from outdoor air with low temperature to the air supply flow (outdoor air 4) in air supply passage 15 can be substantially prevented, and accordingly, a decrease in air supply temperature can be substantially prevented. In summer, heat transfer from outdoor air with high temperature to the air supply flow can be substantially prevented, and accordingly, an increase in air supply temperature can be substantially prevented. Furthermore, thermal insulating layer 18 is optically transparent, and thus carries out a lighting function as a window.

Therefore, without losing a function as a window, decrease in the blowing temperature of the air supply flow in winter can be substantially prevented. Furthermore, an increase in the blowing temperature of the air supply flow in summer can be substantially prevented. In other words, air having a comfortable temperature can be taken into the inside of a room all the year around, so that the effect of enhancing higher comfortability can be achieved.

The air flow direction of exhaust passage 14 may be configured to oppose the air flow direction of air supply passage 15.

With this configuration, the flow direction of supplied air (outdoor air 4) opposes the flow direction of discharged air (exhaust air 3), whereby heat exchange can be carried out in a uniform temperature distribution, so that temperature exchange efficiency in heat transfer plate 16 can be enhanced. Thus, higher heat-exchange-efficiency can be achieved, and accordingly air having a comfortable temperature can be taken into the inside of a room all the year around, so that the effect of enhancing higher comfortability can be achieved.

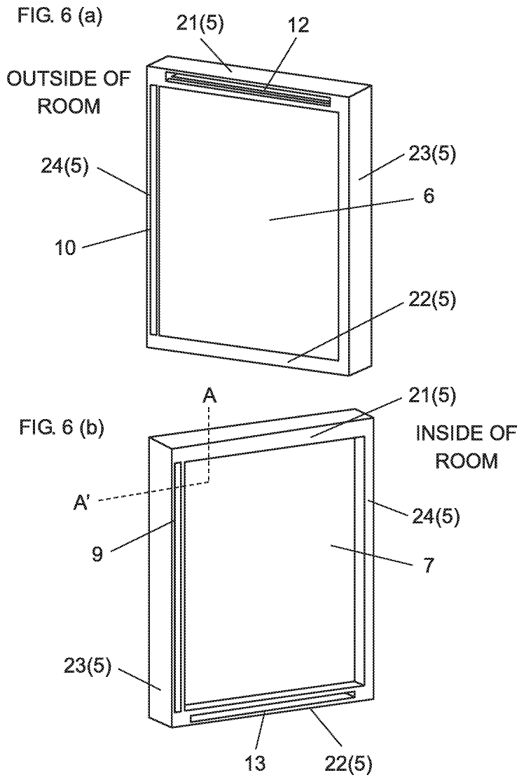

As illustrated in FIG. 6 (a) and FIG. 6 (b), exhaust flow inlet 9 is provided on the indoor side of left side part 23 of window frame 5; exhaust flow outlet 10 is provided on the outdoor side of right side part 24 of window frame 5; air supply flow inlet 12 is provided on the outdoor side of upper side part 21 of window frame 5; and air supply flow outlet 13 is provided on the indoor side of lower side part 22 of window frame 5. Here, the flow direction of an exhaust flow inside heat exchange element 7, the exhaust flow having been taken in from exhaust flow inlet 9, may be configured to be orthogonal to the flow direction of an air supply flow inside heat exchange element 7, the supply air flow having been taken in from air supply flow inlet 12. Note that, in this case, air supply blower 11 is provided in left side part 23 of window frame 5 although, in the previous embodiment, provided inside lower side part 22 of window frame 5. In contrast, exhaust blower 8 is provided inside upper side part 21 of window frame 5 in the same manner as in the previous embodiment.

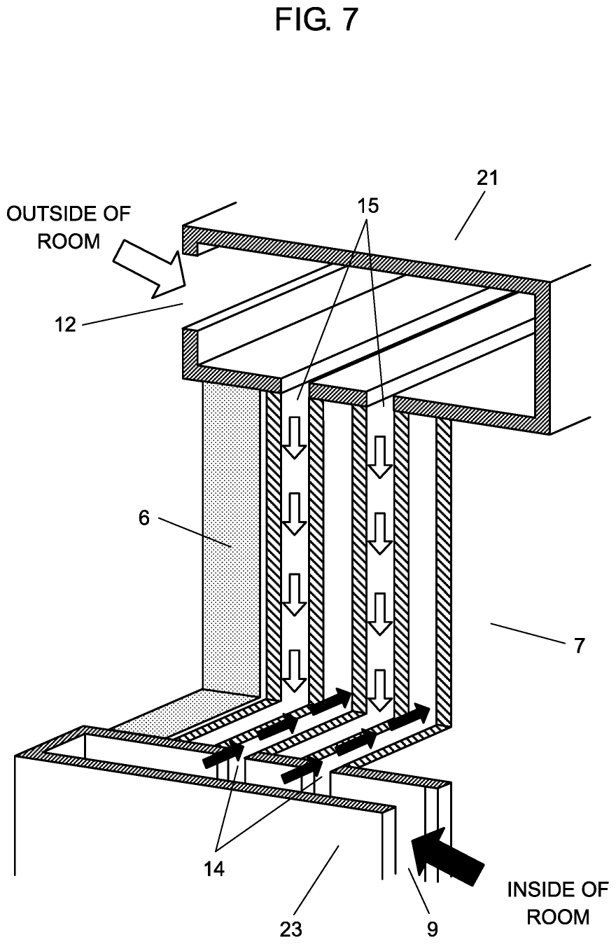

Here, the flow direction of the exhaust flow and the flow direction of the air supply flow in heat exchange element 7 are now described using FIG. 7. FIG. 7 is an enlarged cross-sectional view taken along line A-A′ in FIG. 6 (b). As illustrated in FIG. 7, the exhaust flow taken in from exhaust flow inlet 9 in left side part 23 passes through exhaust passage 14 of heat exchange element 7 from left side part 23 to right side part 24 as indicated by black arrows. The air supply flow taken in from air supply flow inlet 12 provided on the outdoor side of upper side part 21 passes through air supply passage 15 of heat exchange element 7 from upper side part 21 to lower side part 22 as indicated by white arrows. Hence, as illustrated in FIG. 7, the exhaust flow indicated by the black arrows and the air supply flow indicated by the white arrows pass through heat exchange element 7 so as to be at right angles to each other.

Thus, exhaust flow inlet 9, exhaust blower 8, and exhaust flow outlet 10 are linearly configured to extend in one direction, whereas air supply flow inlet 12, air supply blower 11, and air supply flow outlet 13 are linearly configured to extend in another direction being orthogonal to the one direction. In other words, the direction in which exhaust flow inlet 9, exhaust blower 8, and exhaust flow outlet 10 extend is orthogonal to the direction in which air supply flow inlet 12, air supply blower 11, and air supply flow outlet 13 extend. Thus, exhaust passage 14 and air supply passage 15 have a simple air passage structure with fewer turns. This structure can reduce pressure losses and reduce power required for exhaust blower 8 and air supply blower 11. In addition, exhaust flow inlet 9, exhaust flow outlet 10, air supply flow inlet 12, and air supply flow outlet 13 are provided respectively in the four sides of window frame 5, so that indoor air 3 and outdoor air 4 are less likely to be mixed with each other, and efficient ventilation can be achieved.

Thus, a high energy-saving operation in which air blowing power is reduced can be performed, and, in addition, air having a comfortable temperature can be taken into the inside of a room, so that the effect of enhancing higher comfortability can be achieved.

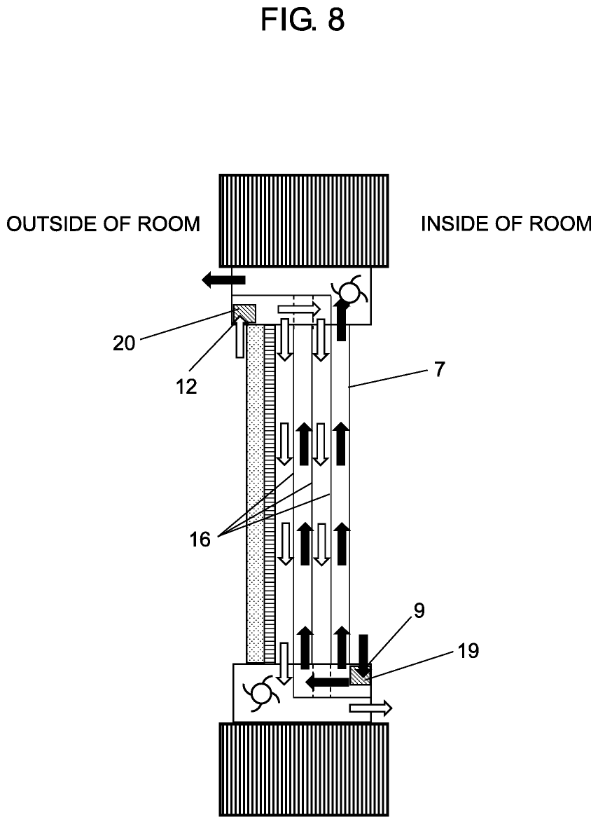

As illustrated in FIG. 8, it may be configured such that exhaust filter 19 is provided to exhaust flow inlet 9, and air supply filter 20 is provided to air supply flow inlet 12. With this configuration, solids such as dust in an outdoor space or an indoor space are prevented from entering into heat exchange element 7, whereby a decrease in exhaust flow rate due to ventilation resistance caused by solids clogging heat exchange element 7 can be prevented, and also dirt can be prevented from adhering to a surface of heat transfer plate 16, so that degradation in lighting performance can be substantially prevented.

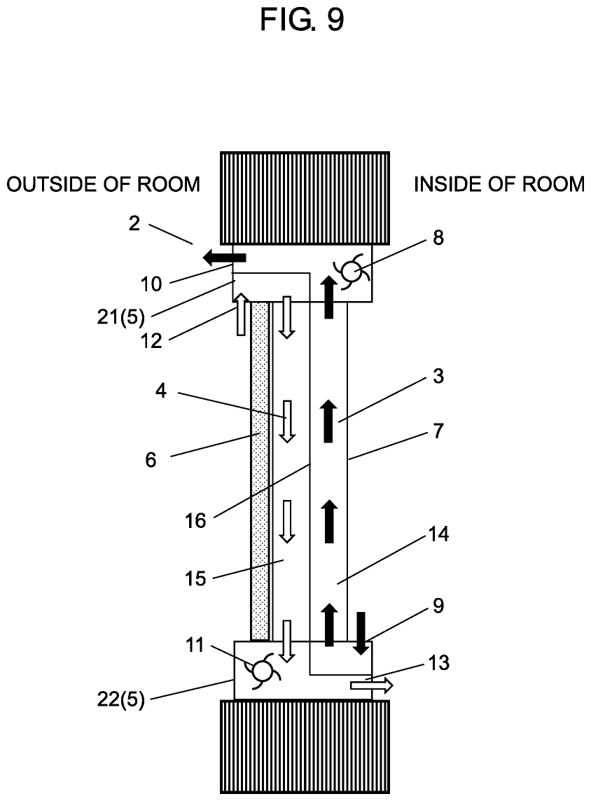

As illustrated in FIG. 9, heat exchange element 7 may be configured to include exhaust passage 14 on the indoor side and air supply passage 15 on the outdoor side that sandwich one sheet of heat transfer plate 16. In other words, heat exchange element 7 may be configured such that exhaust passage 14 on the indoor side, one sheet of heat transfer plate 16, and air supply passage 15 on the outdoor side are disposed in this order. This configuration can make heat exchange ventilator 2 thinner and can offer an enhanced lighting function as a window to heat exchange ventilator 2.

### INDUSTRIAL APPLICABILITY

The heat exchange ventilator according to the present disclosure is useful as a heat exchange ventilator capable of heat exchange between the inside and the outside of a room. The heat exchange ventilator produces an effect when used mainly for windows of buildings.

### REFERENCE MARKS IN THE DRAWINGS

1 . . . wall
2 . . . heat exchange ventilator
3 . . . indoor air
4 . . . outdoor air
5 . . . window frame
6 . . . lighting section
7 . . . heat exchange element
8 . . . exhaust blower
9 . . . exhaust flow inlet
10 . . . exhaust flow outlet
11 . . . air supply blower
12 . . . air supply flow inlet
13 . . . air supply flow outlet
14 . . . exhaust passage
15 . . . air supply passage
16 . . . heat transfer plate
17 . . . low thermal radiation layer
18 . . . thermal insulating layer
19 . . . exhaust filter
20 . . . air supply filter
21 . . . upper side part
22 . . . lower side part
23 . . . left side part
24 . . . right side part
101 . . . heat exchange ventilator
102 . . . window frame
103 . . . exhaust flow inlet
104 . . . exhaust flow outlet
105 . . . heat exchange element
106 . . . exhaust blower
107 . . . air supply flow inlet
108 . . . air supply flow outlet
109 . . . air supply blower

1. A heat exchange ventilator, comprising:
a window frame:
a lighting section provided inside the window frame; and
a heat exchange element superimposed on the lighting section,
wherein the window frame includes:
an exhaust flow inlet provided on an indoor side of the window frame and configured to take in indoor air;
an exhaust flow outlet provided on an outdoor side of the window frame and configured to blow out the indoor air;
an air supply flow inlet provided on the outdoor side and configured to take in outdoor air;
an air supply flow outlet provided on the indoor side and configured to blow out the outdoor air;
an exhaust blower configured to send the indoor air from the exhaust flow inlet to the exhaust flow outlet; and
an air supply blower configured to send the outdoor air from the air supply flow inlet to the air supply flow outlet,
wherein the heat exchange element includes a plurality of heat transfer plates defining a plurality of air passages, each heat transfer plate separating two air passages among the plurality of air passages,
the plurality of heat exchange plates are optically transparent and configured to exchange sensible heat or total heat,
the plurality of air passages including one or more air supply passages and one or more exhaust passages, the one or more air supply passages each being provided between the air supply flow inlet and the air supply flow outlet, the one or more exhaust passages each being provided between the exhaust flow inlet and the exhaust flow outlet, and
the one or more air supply passages and the one or more exhaust passages are alternatively arranged one by one.

2. The heat exchange ventilator according to claim 1,
wherein the heat exchange element is disposed on an indoor side of the lighting section, and includes, on a side facing the lighting section, a low thermal radiation layer configured to interrupt heat radiation from inside a room.

3. The heat exchange ventilator according to claim 1,
wherein, the one or more exhaust passages include an indoor-side air passage which is the closest to a room among the plurality of air passages, and the one or more air supply passages include an outdoor-side air passage which is the farthest to the room among the plurality of air passages.

4. The heat exchange ventilator according to claim 1,
wherein the heat exchange element is in contact with the lighting section via a hollow thermal insulating layer.

5. The heat exchange ventilator according to claim 1,
wherein an air flow direction of the one or more exhaust passages oppose an air flow direction of the one or more air supply passages.

6. The heat exchange ventilator according to claim 1,
wherein the exhaust flow inlet is provided in one side part of one pair of side parts of the window frame, and the exhaust flow outlet is provided in another side part of the one pair of the side parts of the window frame,
wherein the air supply flow inlet is provided in one side part of another pair of side parts of the window frame, and the air supply flow outlet is provided in another side part of the another pair of the side parts of the window frame, and
wherein an air flow direction of the one or more exhaust passages are orthogonal to an air flow direction of the one or more air supply passages.

7. A heat exchange ventilator, comprising:
a window frame:
a lighting section provided inside the window frame; and
a heat exchange element superimposed on the lighting section,
wherein the window frame includes:
an exhaust flow inlet provided on an indoor side of the window frame and configured to take in indoor air;
an exhaust flow outlet provided on an outdoor side of the window frame and configured to blow out the indoor air;
an air supply flow inlet provided on the outdoor side and configured to take in outdoor air;
an air supply flow outlet provided on the indoor side and configured to blow out the outdoor air;
an exhaust blower configured to send the indoor air from the exhaust flow inlet to the exhaust flow outlet; and
an air supply blower configured to send the outdoor air from the air supply flow inlet to the air supply flow outlet,
wherein the heat exchange element includes:
an air supply passage communicated between the air supply flow inlet and the air supply flow outlet, and provided on an outdoor side of the heat exchange element;
an exhaust passage communicated between the exhaust flow inlet and the exhaust flow outlet, and provided on an indoor side of the heat exchange element; and
a heat transfer plate provided between the air supply passage and the exhaust passage, and separating the air supply passage and the exhaust passage, the heat transfer plate being optically transparent and configured to exchange sensible heat or total heat.
